(19) United States
(12) Patent Application Publication
(10) Pub. No.: US 2008/0303770 A1
(43) Pub. Date: Dec. 11, 2008

(54) Liquid Crystal Display Device

(75) Inventors: Ryutaro Oke, Chiba (JP); Yoshihiro Imajo, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/136,167

(22) Filed: Jun. 10, 2008

(30) Foreign Application Priority Data
Jun. 11, 2007 (JP) 2007-153438

(51) Int. Cl. G09G 3/36

(52) U.S. Cl. 345/92

(57) ABSTRACT

A counter voltage supply circuit has an inverting amplifier that inversely amplified a voltage detected from a specified part of a counter electrode of a liquid crystal display panel and supplies the amplified voltage to a counter voltage supply end of the counter electrode. The inverting amplifier includes an operational amplifier having a feedback resistor connected between an inverting input terminal and an output terminal. The feedback resistor includes a first resistor, and n resistors each of which is connected parallel to the first resistor via a switching element. As the n switching elements are selectively turned on and off by a switching element control circuit in accordance with a scanning position, the resistance value of the feedback resistor is varied and the gain of the operational amplifier is changed. Cross-talk due to coupling noise to the counter electrode generated by AC driving of a video voltage and deterioration in display quantity of a display image on the liquid crystal display panel can be prevented.

The present application claims priority from Japanese application JP2007-153438 filed on Jun. 11, 2007, the content of which is hereby incorporated by reference into this application.

### BACKGROUND OF THE INVENTION

1. Field of the Invention

The present invention relates to a liquid crystal display device and particularly to a liquid crystal display device in which a voltage change in a counter electrode of a large-size high-definition liquid crystal display panel is corrected.

2. Description of the Related Art

Recently, liquid crystal display modules have been broadly used for small-size display devices to display devices for OA equipment, large-size television and so on. In the liquid crystal display module, a layer of liquid crystal composite (liquid crystal layer) is held between a pair of insulating substrates, at least one of which is basically made of a transparent glass board, plastic substrate and so on, and a liquid crystal display panel is thus formed.

Particularly, a liquid crystal display module of a TFT system using a thin film transistor as an active element can display a high-definition image and is therefore used as a display device of a television or personal computer display and so on.

Generally, an active-matrix liquid crystal display device employs a longitudinal electric field system in which an electric field to change the orientation of the liquid crystal layer is applied between an electrode formed on one substrate and an electrode formed on the other substrate. Moreover, a liquid crystal display module in which the direction of an electric field applied to the liquid crystal layer is substantially parallel to the substrate surface (this is referred to as a lateral electric field system or in-plane switching (IPS) system) has been practically used.

In this liquid crystal display panel, in an area surrounded by two neighboring scanning lines (also referred to as gate lines) and two neighboring video lines (also referred to as source lines or drain lines), a thin film transistor that turns on when a selective scanning signal from a scanning line is inputted, and a pixel electrode supplied with a video signal from a video line via the thin film transistor are formed, thus constituting a so-called subpixel.

The plural video lines are supplied with a video voltage (gray scale voltage) from a drain driver arranged in a peripheral part of the liquid crystal display panel. The plural scanning lines are supplied with a selective scanning voltage from a gate driver arranged in the peripheral part of the liquid crystal display panel.

As a direct current (DC) is applied to liquid crystal for a long time, the life of the liquid crystal is reduced. Therefore, so-called AC driving is typically carried out in which a video voltage inputted to the pixel electrode of each subpixel is changed to a higher potential than the counter voltage inputted to the counter electrode or to a lower potential than the counter voltage inputted to the counter electrode in a predetermined cycle.

In the active-matrix liquid crystal display module, as the panel has higher definition, the absolute number of video lines increases and coupling noise to the counter electrode at the time of voltage change in the video lines in AC driving increases.

Also, as the liquid crystal panel increases in size, the resistance component from a counter voltage supply source that supplies a counter voltage to the counter electrode cannot be ignored and a problem arises that there a greater difference in coupling noise due to change in the video lines between the near end and far end of the counter voltage supply source.

To deal with this problem, there has been known a technique of supplying the counter electrode with an inverting signal of a voltage change in the counter electrode detected from a specified part, as disclosed in JP-A-6-186530.

However, simply supplying the counter electrode with an inverting signal of a voltage change in the counter electrode detected from a specified part, as disclosed in JP-A-6-186530, not only causes occurrence of chrominance non-uniformity on the liquid crystal display panel that is dependent on the distance from the counter voltage supply source, but also causes deterioration in image quality due to cross-talk and so on.

### SUMMARY OF THE INVENTION

In view of the foregoing circumstances, it is an object of the present invention to prevent cross-talk due to coupling noise to the counter electrode generated in AC driving of a video voltage in the liquid crystal display panel, and to prevent deterioration in display quality of a displayed image on the liquid crystal display panel.

The above and other objects and additional features of the invention will become clear in the description of this specification and the attached drawings.

Typical examples the invention disclosed in the present application and their outlines will be briefly described hereinafter.

(1) A liquid crystal display device according to an aspect of the invention includes a liquid crystal display panel having plural subpixels and plural scanning lines that input a selective scanning voltage to the plural subpixels, and a scanning line driving circuit that sequentially supplies the selective scanning voltage to the plural scanning lines. Each of the plural subpixels has a counter electrode. A counter voltage supply circuit that supplies a counter voltage to the counter electrode is provided. The counter voltage supply circuit has an inverting amplifier that inversely amplifies a voltage detected from a specified part of the counter electrode of the liquid crystal display panel and supplies the voltage to a counter voltage supply end of the counter electrode. The inverting amplifier includes an operational amplifier having a feedback resistor that is connected between an inverting input terminal and an output terminal. The feedback resistor has n resistors and n switching elements that insert the n resistors into a feedback route of the operational amplifier or take out the n resistors from the feedback route of the operational amplifier. A switching element control circuit is provided that selectively turns on and off the n switching elements so as to vary resistance value of the feedback resistor and thus changes a gain of the operational amplifier in accordance with the position of the scanning lines to which the scanning line driving circuit supplies the selective scanning voltage.

(2) In the device of (1), as spacing between the counter voltage supply end and each of the plural scanning lines increases, the gain of the operational amplifier increases.

(3) In the device of (1), the plural scanning lines are divided into plural groups and the gain of the operational amplifier changes for each scanning line of each of the groups.

(4) In the device of (1), the feedback resistor includes a first resistor, and n resistors each of which is connected parallel to the first resistor via the switching element.

(5) In the device of (1), the feedback resister includes a first resistor, n resistors connected in series to the first resistor, and the n switching elements connected parallel to the n resistors.

(6) In the device of (1), when each of resistance values of the n resistors is expressed as R1, R2, . . . , Rn, the relation of Rn=2⁽ⁿ⁻¹⁾×R1 is satisfied.

(7) In the device of (1), the liquid crystal display panel has plural video lines that input a video voltage to the plural subpixels. A video line driving circuit that supplies a video voltage to the plural video lines is provided. The counter voltage supply end of the counter electrode is an end close to the video line driving circuit, of the counter electrode. The specified part of the liquid crystal display panel is an end that is farthest from the video line driving circuit, of the counter electrode.

The advantages of the typical examples of the invention disclosed in this application will be briefly described as follows.

According to the invention, in a large-size high-definition liquid crystal display panel, it is possible to prevent cross-talk due to coupling noise to the counter electrode generated in AC driving of a video voltage, and to prevent deterioration in display quality of a displayed image on the liquid crystal display panel.

### BRIEF DESCRIPTION OF THE DRAWINGS

FIG. 1 shows a schematic configuration of a liquid crystal display module according to an embodiment of the invention.

FIG. 2 is a circuit diagram showing an equivalent circuit of a liquid crystal display panel 1 shown in FIG. 1.

FIG. 3 is a view for explaining the capacity of one subpixel.

FIG. 4 is a schematic view for explaining the state where a counter electrode received coupling by a parasitic capacitance in accordance with a voltage change in a video line.

FIG. 5 is a view showing a counter voltage correcting circuit for a counter electrode described in JP-A-6-186530.

FIG. 6-1 is a circuit diagram showing an exemplary inverting amplifier according an embodiment of the invention.

FIG. 6-2 is a circuit diagram showing an exemplary inverting amplifier according an embodiment of the invention.

FIG. 7 is a timing chart showing an example of on-off timing of switching elements of FIG. 6.

FIG. 8 is a graph showing an exemplary relation between the resistance value of a feedback resistor of an inverting amplifier including an operational amplifier shown in FIG. 6 and the position of a display line.

FIG. 9 shows a display pattern in which cross-talk tends to occur.

### DETAILED DESCRIPTION OF THE PREFERRED EMBODIMENTS

Hereinafter, an embodiment of the invention will be described in detail with reference to the drawings.

In all the drawings for explaining the embodiment, parts and units having the same functions are denoted by the same reference numerals and their description will be repeated.

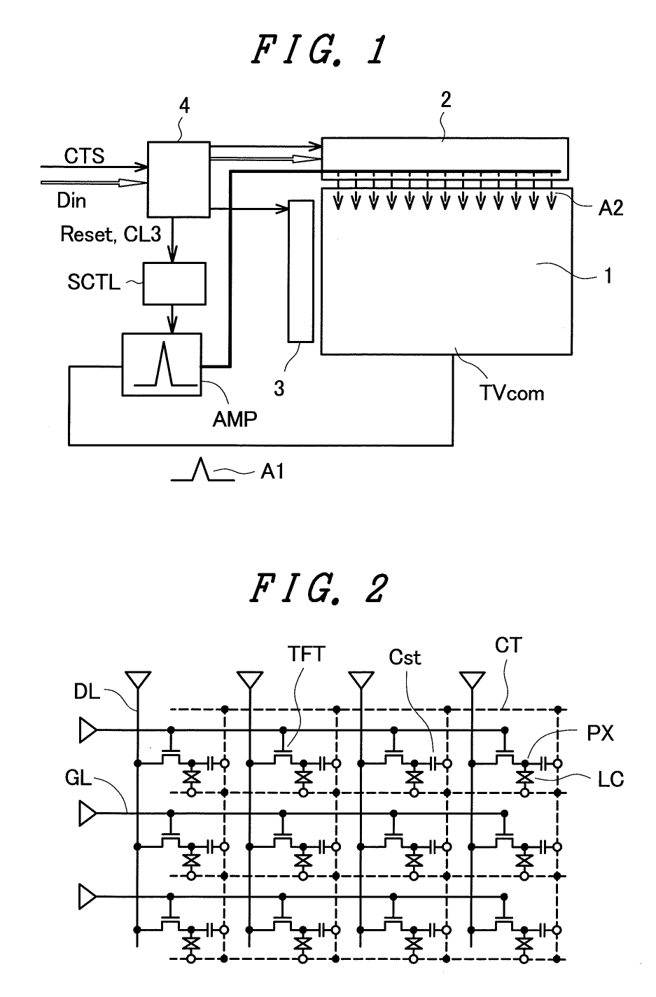

FIG. 1 shows a schematic configuration of a liquid crystal display module according to an embodiment of the invention. FIG. 2 is a circuit diagram showing an equivalent circuit of a liquid crystal display panel 1 shown in FIG. 1.

The liquid crystal display module of this embodiment includes the liquid crystal display panel 1, a drain driver 2, a gate driver 3, a display control circuit 4, and a power supply circuit (not shown).

The liquid crystal display module of this embodiment has a counter voltage detection terminal (TVcom), an inverting amplifier (AMP), and a switching element control circuit (SCTL), as a pixel position-corresponding counter voltage correcting circuit.

The drain driver 2 and the gate driver 3 are installed in peripheral parts of the display panel 1. For example, the drain driver 2 and the gate driver 3 are mounted respectively by a COG method in peripheral parts on two sides of a first substrate of a pair of substrates (for example, glass boards) of the liquid crystal display panel 1. Alternatively, the drain driver 2 and the gate driver 3 are mounted respectively by a COF method on flexible circuit boards arranged in peripheral parts on two sides of the first substrate of the liquid crystal display panel 1.

The display control circuit 4 and the power supply circuit are mounted respectively on circuit boards arranged in peripheral parts of the liquid crystal display panel 1 (for example, the back side of the liquid crystal display module) The power supply circuit generates various voltages required for the liquid crystal display device.

The display control circuit 4 carries out timing adjustment suitable for display on the liquid crystal display panel 1, such as AC conversion of data, of a display control signal (CTS) and display data (Din) inputted from a display signal source (host side) like a personal computer or television receiving circuit, converts the data into display data according to a display format, and inputs the data to the drain driver 2 and the gate driver 3 together with a synchronizing signal (clock signal).

The gate driver 3 sequentially supplies a selective scanning voltage to scanning lines (also referred to as gate lines (GL)) under the control of the display control circuit 4. The drain driver 2 supplies a video voltage to video lines (also referred to as drain lines and source lines (DL)) to display a video.

As shown in FIG. 2, the liquid crystal display panel 1 has plural subpixels. Each subpixel is provided in an area surrounded by video lines (DL) and scanning lines (GL).

Each subpixel has a thin film transistor (TFT). A first electrode (drain electrode or source electrode) of the thin film transistor (TFT) is connected to a video line (DL). A second electrode (source electrode or drain electrode) of the thin film transistor (TFT) is connected to a pixel electrode (PX). The gate electrode of the thin film transistor (TFT) is connected to a scanning line (GL).

In FIG. 2, LC represents liquid crystal capacitance equivalently showing a liquid crystal layer arranged between a pixel electrode (PX) and a counter electrode (CT). Cst represents a retention capacitance formed between a pixel electrode (PC) and a counter electrode (CT).

In the liquid crystal display panel 1 shown in FIG. 1, the first electrode of the thin film transistor (TFT) of each subpixel arranged in the direction of column is connected to a video line (DL), and each video line (DL) connects the drain driver 2 that supplies a video voltage (gray scale voltage) corresponding to display data, to the subpixels arranged in the direction of column.

The gate electrode of the thin film transistor (TFT) of each subpixel arranged in the direction of row is connected to a scanning line (GL), and each scanning line (GL) is connected to the gate driver 3 that supplies a scanning voltage (positive or negative bias voltage) to the gate of the thin film transistor (TFT) for one horizontal scanning time.

The display control circuit 4 includes one semiconductor integrated circuit (LSI) and controls and drives the drain driver 2 and the gate driver 3 in accordance with externally inputted various display control signals including dot clock (DCLK), display timing signal (DTMG), external horizontal synchronizing signal (Hsync) and external vertical synchronizing signal (Vsync), and display data.

When a display timing signal (DTMG) is inputted, the display control circuit 4 determines this as a display start position and outputs a received simple column of display data to the drain driver 2 via a display data bus line.

At this time, the display control circuit 4 outputs a display data latch clock signal (CL2), which is a display control signal for latching display data, to a data latch circuit of the drain driver 2 via a signal line.

When the input of the display timing signal (DTMG) has been finished or a predetermined time has passed since the input of the display timing signal (DTMG), the display control circuit 4 assumes that one horizontal line of display data has been finished, and outputs an output timing control clock signal (CL1), which is a display control signal for outputting the display data stored in the latch circuit of the drain driver 2 to a video line (DL) of the liquid crystal display panel 1, to the drain driver 2 via a signal line. Thus, the drain driver 2 supplies a video voltage corresponding to the display data to the video lines (DL).

As the first display timing signal is inputted after the input of a vertical synchronizing signal, the display control circuit 4 determines this as the first display line and outputs a frame start designating signal (FLM) to the gate driver 3 via a signal line.

Moreover, in accordance with a horizontal synchronizing signal, the display control circuit 4 outputs a shift clock (CL3) of one horizontal scanning time cycle to the gate driver 3 via a signal line so that a selective scanning voltage (positive bias voltage) is sequentially supplied to each scanning line (GL) of the liquid crystal display panel 1, everyone horizontal scanning time.

Thus, the plural thin film transistors (TFT) connected to each scanning line (GL) of the liquid crystal display panel 1 are electrically connected for one horizontal scanning time.

The voltage supplied to the video lines (DL) is applied to pixel electrodes (PX) via the thin film transistors (TFT), which are electrically connected for one horizontal scanning time. Eventually, as the retention capacitances (Cst) and the liquid crystal capacitances (LC) are electrically charged to control the liquid crystal molecules, an image is displayed.

The liquid crystal display panel 1 is formed by superimposing, with a predetermined spacing, the first substrate on which the pixel electrodes (PX), thin film transistors (TFT) and so on are formed and the second substrate on which a color filter and so on are formed, then bonding the two substrates with a sealant provided in the shape of a frame near peripheral edges between the two substrates, then filling the space inside of the sealant between the two substrates with liquid crystal from a liquid crystal encapsulation port provided at a part of the sealant and encapsulating the liquid crystal, and then bonding a polarizer onto the outside of the two substrates.

The counter electrodes (CT) are provided on the second substrate if it is a liquid crystal display panel of the TN system or VA system. In the case of the IPS system, the counter electrodes (CT) are provided on the first substrate.

Since the present invention is not related to the internal structure of the liquid crystal panel, the detailed description of the internal structure of the liquid crystal panel is omitted. Moreover, the present invention can be applied to a liquid crystal panel of any structure.

The counter electrodes (CT) are connected to have the same potential in the entire liquid crystal display panel. A voltage from the inverting amplifier (AMP) is supplied to the counter electrodes (CT) of the liquid crystal display panel via the drain driver circuit board, as indicated by A2 in FIG. 1.

In this embodiment, in order to correct a change at the counter electrodes (CT) due to a voltage change in the video lines (DL), the counter voltage detection terminal (TVcom) is provided at the farthest end from the counter voltage supply point of the counter electrodes (CT), and a voltage (A1 in FIG. 1) detected by this counter voltage detection terminal (TVcom) is inputted to the inverting amplifier (AMP).

The inverting amplifier (AMP) includes an operational amplifier, as will be described later. The gain of the inverting amplifier (AMP) changed in accordance with the display line position.

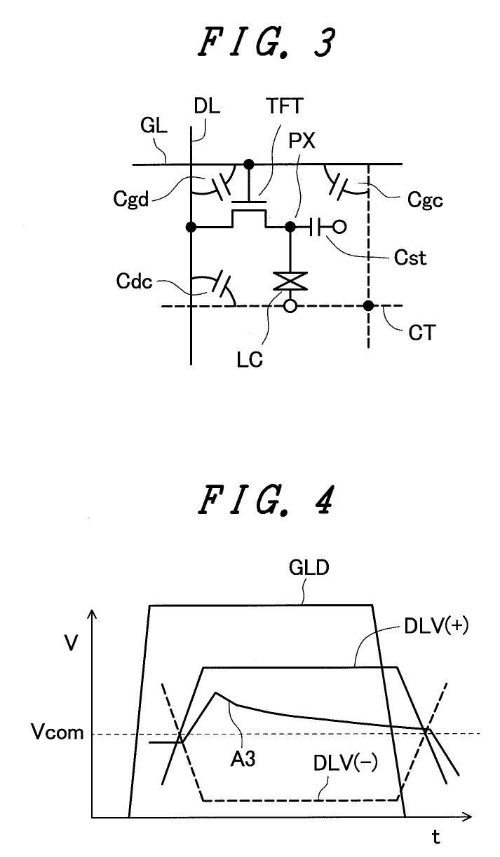

FIG. 3 is a view for explaining a part that constitutes the capacitance of one subpixel. In FIG. 3, LC represents the liquid crystal capacitance of the subpixel, Cdc represents the parasitic capacitance between the video line and the counter electrode, Cgc represents the parasitic capacitance between the scanning line and the counter electrode, and Cgd represents the parasitic capacitance between the scanning line and the video line.

FIG. 4 is a schematic view for explaining the state where the counter electrode (CT) receives coupling by the parasitic capacitance in accordance with voltage change in the video lines (DL).

The video lines (DL) are typically set in such a manner that the voltages of two neighboring video lines (DL) are driven in opposite polarities in order to reduce flicker. In FIG. 4, DLV(+) represents a positive video voltage of the video lines (DL), and DLV(−) represents a negative video voltage of the video lines (DL). GLV represents a selective scanning voltage of the scanning lines (GL).

As described above, the video voltage inputted to the video lines (DL) has its polarity inverted with respect to the counter voltage (Vcom) of the counter electrode (CT) in a predetermined cycle in order to prevent application of a direct current (DC) to the liquid crystal.

However, when a specified pattern is displayed, the video voltage of one polarity inputted to the video lines (DL) increases and the potential of the counter electrode (CT) changes because of the coupling by the parasitic capacitance, as indicated by A3 in FIG. 4.

After that, as the counter voltage (Vcom) is supplied from the counter voltage supply circuit (here, the inverting amplifier (AMP)), the voltage of the counter electrode (CT) returns to the original counter voltage (Vcom). However, in the case where the original counter voltage (Vcom) cannot be restored before the scanning lines (GL) turn off, a different voltage from the voltage that should be originally written is written to the liquid crystal capacitance (LC). This is a writing error and deteriorates the display quality.

In a relatively small liquid crystal display panel, since the area of the counter electrode (CT) is small, the original potential is easily restored even when there is a change in the counter electrode (CT), and the display quality is less likely to deteriorate. However, in a high-definition panel, as the number of video lines (DL) increases, the influence of the parasitic capacitance (Cdc) between the video line and the counter electrode, and of the parasitic capacitance (Cgc) between the scanning line and the counter electrode through the parasitic capacitance (Cgd) between the scanning line and the video line increases.

Also, recently, as the frame refresh rate of the liquid crystal display panel 1, double-speed or triple-speed driving is carried out to support dynamic images, and the on-time of the gate is increasingly reduced. Since the time required for the counter electrode (CT) having a voltage change to restore the original counter voltage (Vcom) is insufficient, a writing error occurs and deterioration in image quality such as cross-talk become prominent.

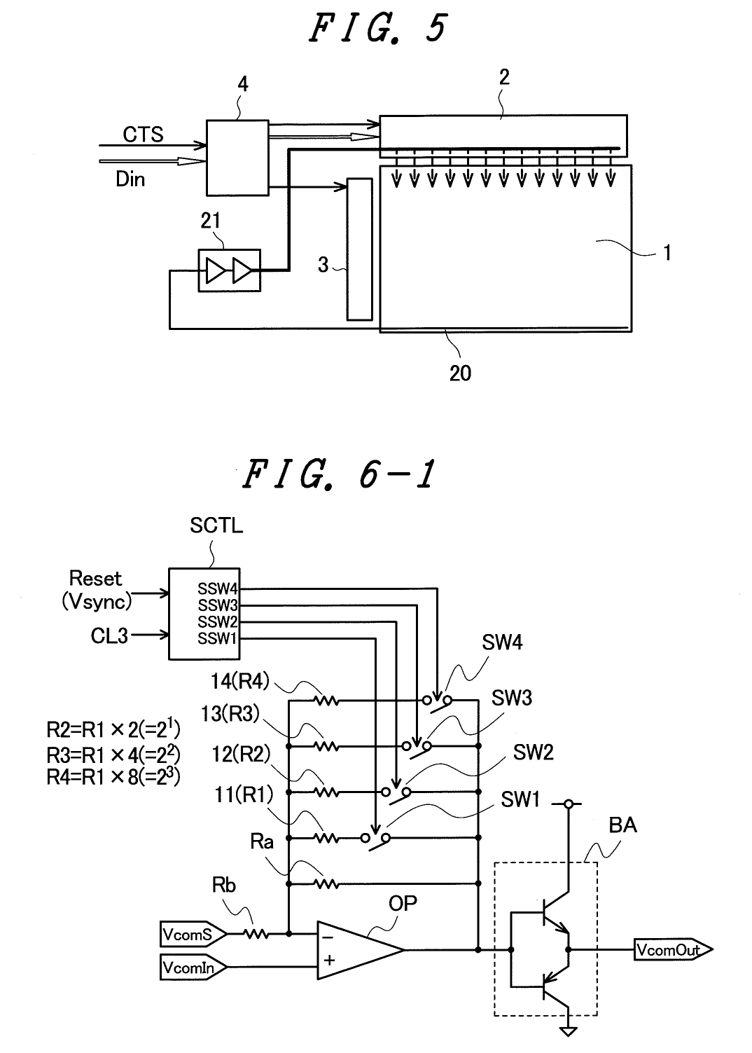

FIG. 5 is a view showing the counter voltage correcting circuit of the counter electrode (CT) described in JP-A-6-186530. In the counter voltage correcting circuit of the counter electrode (CT) described in JP-A-6-186530, a voltage change in the counter electrode (CT) detected by a sensing line 20 is inputted to an inverting circuit 21, and this inversion signal is supplied to the counter electrode (CT).

In the liquid crystal display device described in JP-A-6-186530, measures for the supply to the counter electrode (CT) of the liquid crystal display panel are taken such as providing a supply line on the outermost periphery of the liquid crystal display panel. However, since this increases the size of the liquid crystal display panel itself, the resistance component in the liquid crystal display panel cannot be ignored and the time constant difference at the time of supplying the counter voltage expands between a part close to the counter voltage supply end and the far end. Therefore, for example, in the case where the voltage of the counter electrode (CT) located at the farthest position from the counter voltage supply end of the liquid crystal display panel is detected and corrected, this correction turns out to be excessive on the side close to the counter voltage supply end of the liquid crystal display panel, but the correction is insufficient on the far end side because of the resistance component in the liquid crystal display panel.

However, in the case of the counter voltage correcting circuit according to this embodiment, while the detected voltage is amplified by the inverting amplifier (AMP) and then supplied to the counter electrode (CT), the gain of the inverting amplifier (AMP) is set on the basis of the distance between the scanning line (GL) that is now being scanned and the counter voltage supply end in consideration of the resistance component in the liquid crystal display panel. Therefore, uniform correction can be made in the liquid crystal display panel.

Hereinafter, a specific example of this embodiment will be described.

As shown in FIG. 1, the counter voltage (Vcom) is generated in the peripheral circuit and is supplied to the counter electrode (CT) of the liquid crystal display panel 1 via the low-resistance video line driving circuit board. In the case of FIG. 1, the top part of the liquid crystal display panel is close to the counter voltage supply end and the bottom part of the liquid crystal display panel is the far end side from the counter voltage supply end.

The counter electrode (CT) is influenced by AC driving of the video lines (DL) via the liquid crystal capacitance (LC) and each parasitic capacitance (Cdc, Cgc, Cgd). Its quantity is defined by the difference in quantity of variance to positive polarity or negative polarity of the video lines (DL) on one display line.

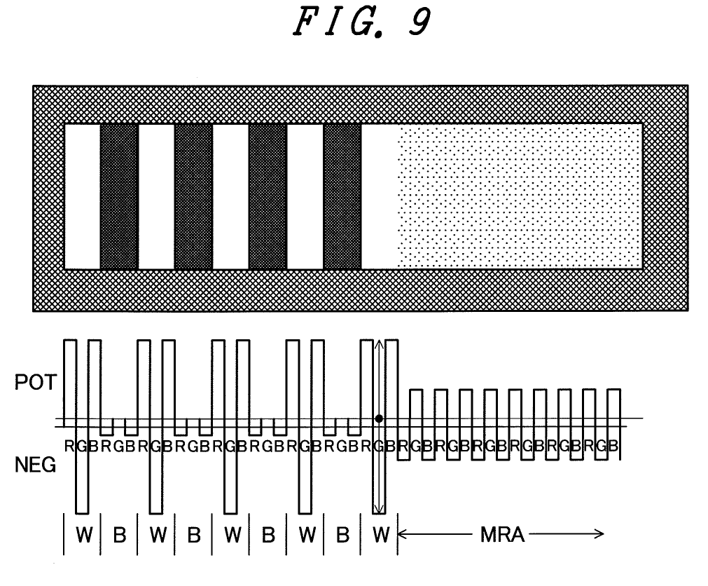

FIG. 9 shows a display pattern in which cross-talk tends to occur. Generally, one pixel in the panel of the liquid crystal display module includes a set of subpixels of three primary colors R, G and B. Pixels are arranged in a repeated manner in order of the subpixels of R, G and B. A video line (DL) and a liquid crystal capacitance (LC) are connected to each of the subpixels of R, G and B, and a video voltage, which is image information, is supplied thereto from the drain driver 2.

Generally, video voltages supplied to neighboring video lines (DL) are set to have opposite polarities. For example, in the case of normally black liquid crystal, at the time of white display, a maximum video voltage of positive polarity (POT) is applied to the R and B subpixels and a maximum video voltage of negative polarity (NEG) is applied to the G subpixel. In the case where this is repeated, that is, in the case where white and black are alternately displayed by each pixel, the number of G video lines (DL) supplied with the negative-polarity video voltage is half the number of R and B video lines (DL) supplied with the positive-polarity video voltage in one line. Because of coupling due to voltage change in the video lines (DL), the voltage of the counter electrode (CT) shifts to positive polarity, as indicated by A in FIG. 9.

In this state, in the case where the scanning lines (GL) are off, that is, where writing of the voltage to the liquid crystal capacitance (LC) has been finished, a relatively high voltage has been written only to the G subpixel, compared to the supplied video voltage. Thus, white shifts to green. Moreover, in the area where medium tone (MRA) is shown on the same display line, contrast occurs by each one pixel and a phenomenon of deterioration in image quality called cross-talk is observed.

In this embodiment, to overcome the deterioration in image quality due to the change in the counter voltage, a corrected voltage corresponding to the display line position of the liquid crystal display panel is provided to the counter electrode (CT) by a pixel position-corresponding counter voltage correcting circuit.

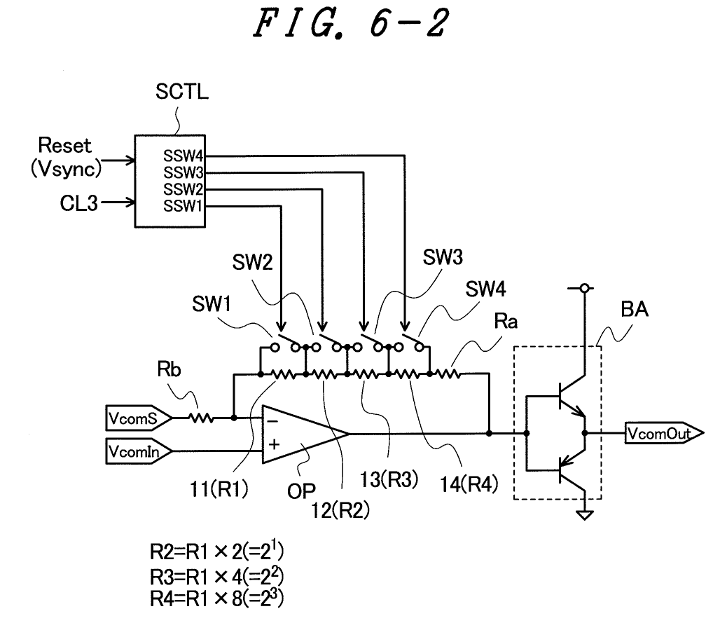

FIG. 6-1 is a circuit diagram showing an example of the inverting amplifier according to this embodiment. FIG. 6-1 shows an inverting amplifier using an operational amplifier (OP). A buffer circuit (BA) including a bipolar transistor is connected to the output terminal of the operational amplifier (OP). A feedback resistor is connected between the inverting input terminal (−) and the output terminal of the operational amplifier (OP). This feedback resistor includes a resistor Ra and a parallel circuit of resistors R1 to R4.

The inverting amplifier shown in FIG. 6-1 inversely amplifies a voltage (VcomS) from the counter voltage detection terminal (TVcom) on the bottom part of the liquid crystal display panel, provided at the farthest end from the counter voltage supply end of the liquid crystal display panel 1, and supplies the amplified voltage (VcomOut) to the counter electrode (CT) as the counter voltage (Vcom). In FIG. 6-1, VcomIn represents the original counter voltage (Vcom).

In this case, when the scanning lines (GL) on the top part of the liquid crystal display panel, which is close to the counter voltage supply end, are being scanned, the gain of the inverting amplifier is lowered to prevent excessive correction. When the scanning lines (GL) on the bottom part of the liquid crystal display panel, which is the far end, are being scanned, the gain is raised in consideration of the resistance component in the liquid crystal display panel, thus compensating for the insufficient correction.

In this embodiment, as a method of changing the gain of the inverting amplifier in accordance with this scanning, the feedback resistance of the inverting amplifier including the operational amplifier (OP) is varied. To this end, in this embodiment, the resistors 11 to 14 are connected parallel to the resistor Ra via switching elements (SW1 to SW4), as shown in FIG. 6-1, and the switching elements (SW1 to SW4) are selectively turned on and off by a switching element control circuit (SCTL). Thus, the feedback resistance is varied.

Here, when the resistance value of the resistor 11 is R1, the resistance value R2 of the resistor 12 is R2=2^{(2-1) )}×R1, the resistance value R3 of the resistor 13 is R3=4(2⁽³⁻¹⁾×R1, and the resistance value R4 of the resistor 14 is R4=8(2⁽⁴⁻¹⁾×R1. That is, the resistors 11 to 14 are weighted.

In the case where n resistors (in FIG. 6-1, four resistors 11 to 14) are connected to the resistor Ra, in this embodiment, when the feedback resistance of the operational amplifier (OP) is varied in accordance with scanning, all the scanning lines are divided into 2ⁿ (in FIG. 6-1, 2⁴=16) groups and the feedback resistance of the operational amplifier (OP) is varied by each of the divided groups.

Therefore, the switching element control circuit (SCTL) has an inner counter to count the inputted shift clock (CL3), determines which group the scanned scanning line (GL) belongs to in accordance with the count value of the counter, and selectively turns on and off the switching elements (SW1 to SW4) in accordance with switching element control signals (SSW1 to SSW4).

Reset in FIG. 6-1 represents a signal synchronized with the vertical synchronizing signal (Vsync) (or the vertical synchronizing signal (Vsync)). This signal is for resetting the inner counter.

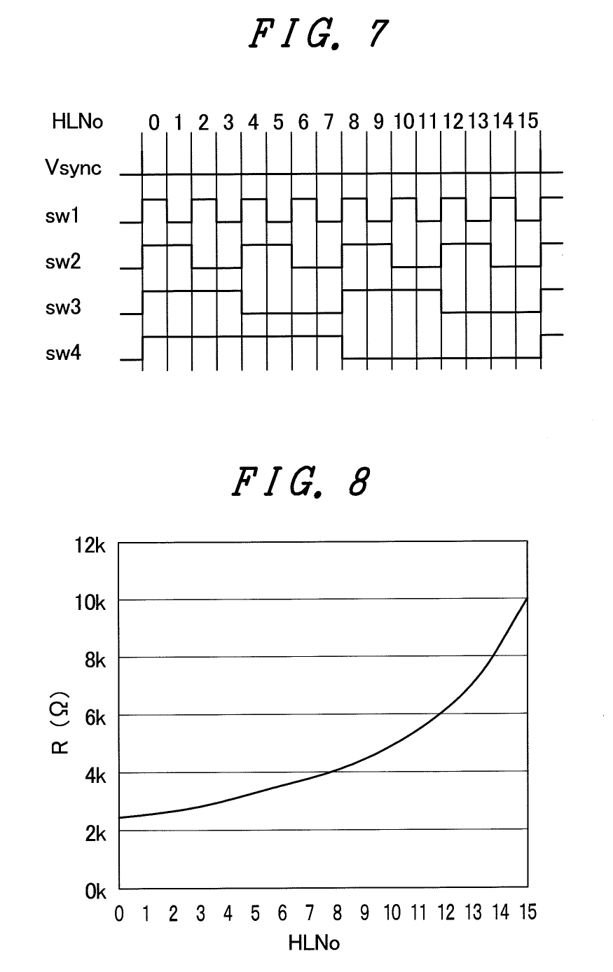

FIG. 7 shows an example of on-off timing of the switching elements (SW1 to SW4). FIG. 8 shows an example of the relation between the resistance value of the feedback resistor of the inverting amplifier including the operational amplifier and the display line position in this case. In FIG. 7 and FIG. 8, HLNo represents the display line position and corresponds to the scanning lines of each of the 16 divided groups.

Generally, the gain of the inverting amplifier including the operational amplifier (OP) is expressed by (−Ra/Rb) Therefore, in the case where the resistance value of the feedback resistor changes as shown in FIG. 8, the gain of the inverting amplifier including the operational amplifier (OP) changes in the same manner as shown in FIG. 8. Thus, when the scanning lines (GL) on the top part of the liquid crystal display panel, which is close to the counter voltage supply end, are being scanned, the gain of the inverting amplifier can be lowered, whereas when the scanning lines (GL) on the bottom part of the liquid crystal display panel, which is the far end, are being scanned, the gain can be raised in consideration of the resistance component in the liquid crystal display panel.

FIG. 6-2 is a circuit diagram showing another example of the inverting amplifier according to this embodiment. The inverting amplifier shown in FIG. 6-2 is different from the inverting amplifier shown in FIG. 6-1 in that the resistors 11 to 14 are connected in series to the resistor Ra and that the switching elements (SW1 to SW4) of the resistors 11 to 14 are connected in parallel.

Also in the inverting amplifier shown in FIG. 6-2, the feedback resistance can be varied as the switching elements (SW1 to SW4) are selectively turned on and off by the switching element control circuit (SCTL). In FIG. 6-1 and FIG. 6-2, the resistors connected in series or parallel to the resistor (Ra) are not limited to four resistors. Two, three, or six or more resistors can be connected.

As described above, in this embodiment, in the liquid crystal display panel (particularly a large-size high-definition liquid crystal display panel), a change in the counter voltage (Vcom) due to AC driving of the video lines (DL) is corrected in accordance with the distance from the counter voltage supply end. Therefore, deterioration in image quality due to insufficient writing caused by coupling noise to the counter electrode (CT) generated by AC driving of the video lines (DL), or deterioration in image quality due to the cross-talk phenomenon on the entire surface of the liquid crystal display panel can be solved.

The invention made by the present inventor has been specifically described with reference to the embodiment. However, the present invention should not be limited to the embodiment and various changes and modifications can be made without departing from the scope of the invention.

What is claimed is:

1. A liquid crystal display device comprising:
a liquid crystal display panel having plural subpixels and plural scanning lines that input a selective scanning voltage to the plural subpixels; and
a scanning line driving circuit that sequentially supplies the selective scanning voltage to the plural scanning lines;
each of the plural subpixels having a counter electrode;
the device having a counter voltage supply circuit that supplies a counter voltage to the counter electrode; and
the counter voltage supply circuit having an inverting amplifier that inversely amplifies a voltage detected from a specified part of the counter electrode of the liquid crystal display panel and supplies the voltage to a counter voltage supply end of the counter electrode;
wherein the inverting amplifier includes an operational amplifier having a feedback resistor that is connected between an inverting input terminal and an output terminal;
the feedback resistor has n resistors and
n switching elements that insert the n resistors into a feedback route of the operational amplifier or take out the n resistors from the feedback route of the operational amplifier; and
a switching element control circuit is provided that selectively turns on and off the n switching elements so as to vary resistance value of the feedback resistor and thus changes a gain of the operational amplifier in accordance with the position of the scanning lines to which the scanning line driving circuit supplies the selective scanning voltage.

2. The liquid crystal display device according to claim 1, wherein as spacing between the counter voltage supply end and each of the plural scanning lines increases, the gain of the operational amplifier increases.

3. The liquid crystal display device according to claim 1, wherein the plural scanning lines are divided into plural groups and
the gain of the operational amplifier changes for each scanning line of each of the groups.

4. The liquid crystal display device according to claim 1, wherein the feedback resistor includes a first resistor, and
n resistors each of which is connected parallel to the first resistor via the switching element.

5. The liquid crystal display device according to claim 1, wherein the feedback resister includes a first resistor,
n resistors connected in series to the first resistor, and
the n switching elements connected parallel to the n resistors.

6. The liquid crystal display device according to claim 1, wherein when each of resistance values of the n resistors is expressed as R1, R2, . . . , Rn, the relation of R=2⁽ⁿ⁻¹⁾×R1 is satisfied.

7. The liquid crystal display device according to claim 1, wherein the liquid crystal display panel has plural video lines that input a video voltage to the plural subpixels,
the device has a video line driving circuit that supplies a video voltage to the plural video lines,
the counter voltage supply end of the counter electrode is an end close to the video line driving circuit, of the counter electrode, and
the specified part of the liquid crystal display panel is an end that is farthest from the video line driving circuit, of the counter electrode.
